(19) United States
(12) Patent Application Publication
(10) Pub. No.: US 2014/0244360 A1
(43) Pub. Date: Aug. 28, 2014

(54) CUSTOMER UNIVERSE EXPLORATION

(71) Applicant: WAL-MART STORES, INC., Bentonville, AR (US)

(72) Inventor: David Patterson, Berkeley, CA (US)

(73) Assignee: Wal-Mart Stores, Inc., Bentonville, AR (US)

(21) Appl. No.: 13/779,623

(22) Filed: Feb. 27, 2013

(51) Int. Cl. G06Q 30/02

(52) U.S. Cl. CPC G06Q 30/0204
USPC 705/7.33

(57) ABSTRACT

The present disclosure extends to methods, systems, and computer program products for identifying attributes associated with potential customers. Attribute data contained in a potential customer database are transformed into bit sets or binary fingerprints. These bits sets or binary fingerprints are then clustered into clusters based on similarities between the bits sets, which correspond to similarities of the attributes. These clusters are represented graphically in a two- or three-dimensional map. The two- or three-dimensional map is analyzed to identify attributes associated with the potential customers.

### BACKGROUND

The portion of the potential customer population that a company can reach through marketing, and the portion of customers not yet reached, is an important aspect of segment targeting for any retail company. Typically, retailers analyze this problem one aspect at a time, such as “married vs. single” or “male vs. female.” Customers and potential customers, however, are multivariate, with many demographic attributes and many behavioral and preference attributes. There is value in enabling marketing and other non-mathematical professionals being able to explore the universe of all customers and compare it to the universe of all existing customers. The large number of individuals and their associated behavioral and demographic attributes makes analyzing a merchant's actual and potential customer database difficult and costly with current methods and systems.

These problems apply even with the use of computers and current computing systems. The disclosed methods and systems herein, provide efficient and cost effective methods and systems for merchants to analyze populations segments for targeted advertising. The disclosed methods, features, systems, and computer program products operate to identify attributes associated with potential customers. More specifically, attribute data contained in a potential customer database are transformed into bit sets or binary fingerprints. These bits sets or binary fingerprints are then clustered into clusters based on similarities between the bits sets, which correspond to similarities of the attributes. These clusters are represented graphically in a two- or three-dimensional map. The two- or three-dimensional map is analyzed to identify attributes associated with the potential customers.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example computer architecture that facilitates different implementations described herein;

FIG. 3 illustrates a flow chart of an example method according to one implementation.

FIG. 4a illustrates a two-dimensional map of clusters according to one implementation.

FIG. 4b illustrates a two-dimensional map of binary fingerprints from a selected cluster according to one implementation.

### DETAILED DESCRIPTION

The present disclosure extends to methods, systems, and computer program products for providing merchant database updates for new product items. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

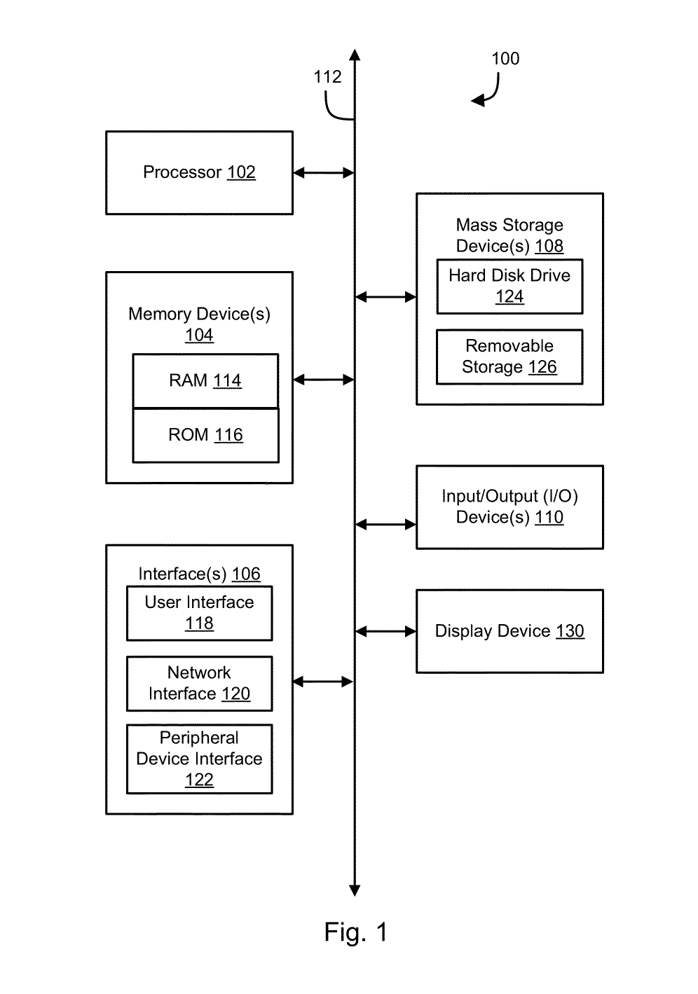

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

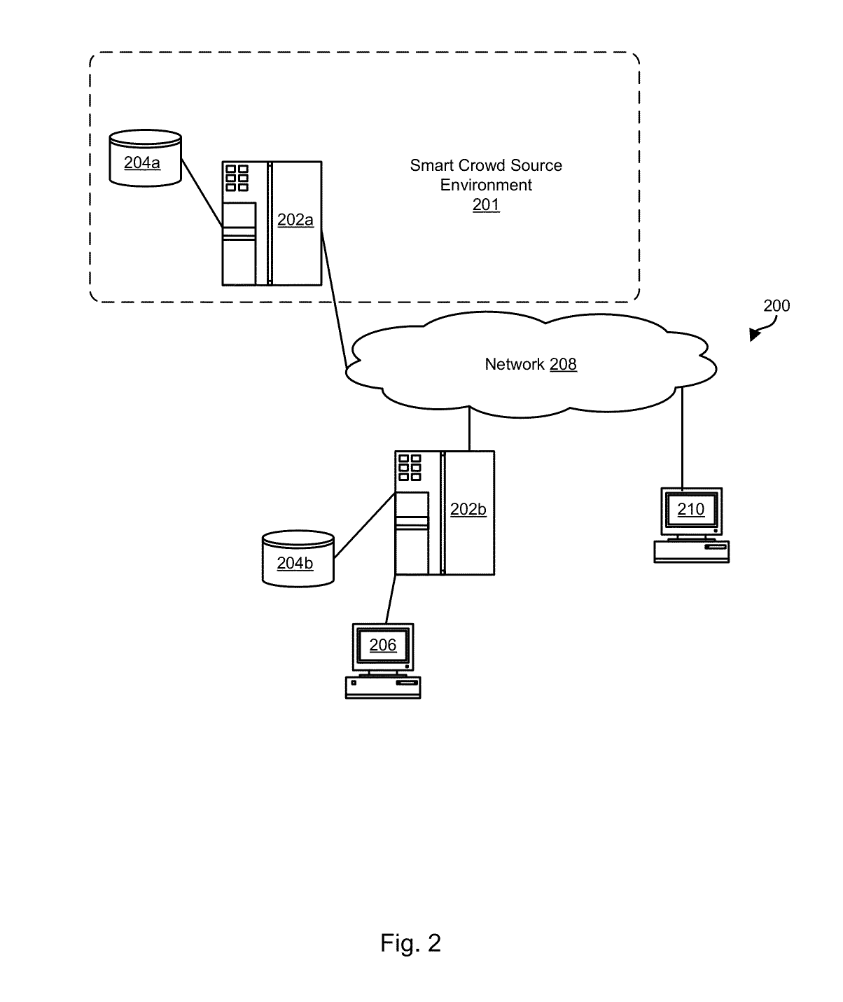

FIG. 2 illustrates an example of a computing environment 200 and a smart crowd source environment 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

As used herein, a smart crowd source environment is a group of users connected over a network that are assigned tasks to perform over the network. In an implementation the smart crowd source may be in the employ of a merchant, or may be under contract with on a per task basis. The work product of the smart crowd source is generally conveyed over the same network that supplied the tasks to be performed. In the implementations that follow, users or members of a smart crowd source may be tasked with reviewing the classification of new product items and the hierarchy of products within a merchant's database.

A server 202b may be associated with a classification manager or other entity or party providing classification work. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

As used herein, a classification model pipeline is intended to mean plurality of classification models organized to optimize the classification of new product items that are to be added to a merchant database. The plurality of classification models may be run in a predetermined order or may be run concurrently. The classification model pipeline may require that new product items be processed by all of the classification models within the pipeline, or may allow the classification process to stop before all of the classification models are run if predetermined thresholds are not met.

It is to be further understood that the phrase “computer system,” as used herein, shall be construed broadly to include a network as defined herein, as well as a single-unit work station (such as work station 206 or other work station) whether connected directly to a network via a communications connection or disconnected from a network, as well as a group of single-unit work stations which can share data or information through non-network means such as a flash drive or any suitable non-network means for sharing data now known or later discovered.

An illustrative embodiment of the present invention comprises a method of identifying segments of the potential customer population according to behavioral and demographic attributes. The portion of the potential customer population that a company can reach, and the portion of potential customers not yet reached, is an important aspect of segment targeting for any retail company. As used herein, “segment” means a portion of the potential customer population as defined by a large set of behavioral and demographic attributes. For example, a segment comprising several thousand individuals might be defined by some 400 different attributes. Very simplistically, an illustrative segment might be described very briefly as married white males of ages 35-40 with children in the home, a college education, and an annual salary of $50,000 to $75,000. Since many more attributes are involved in defining a segment than were mentioned in the previous sentence, it is possible to define segments of the population in such a way that the segment may contain only about 1000 to about 10,000 individuals, for example. There is value to a company in enabling company personnel to explore the universe of all potential customers and compare it to the universe of all existing customers. In this way, the company can determine where there are “holes” in its marketing efforts. That is, it can determine where improvement is needed to target its marketing efforts at individuals having certain behavioral and demographic characteristics. Similarly, it can determine where it is doing a good job of targeting customers and that would be most amenable to continued marketing outreach.

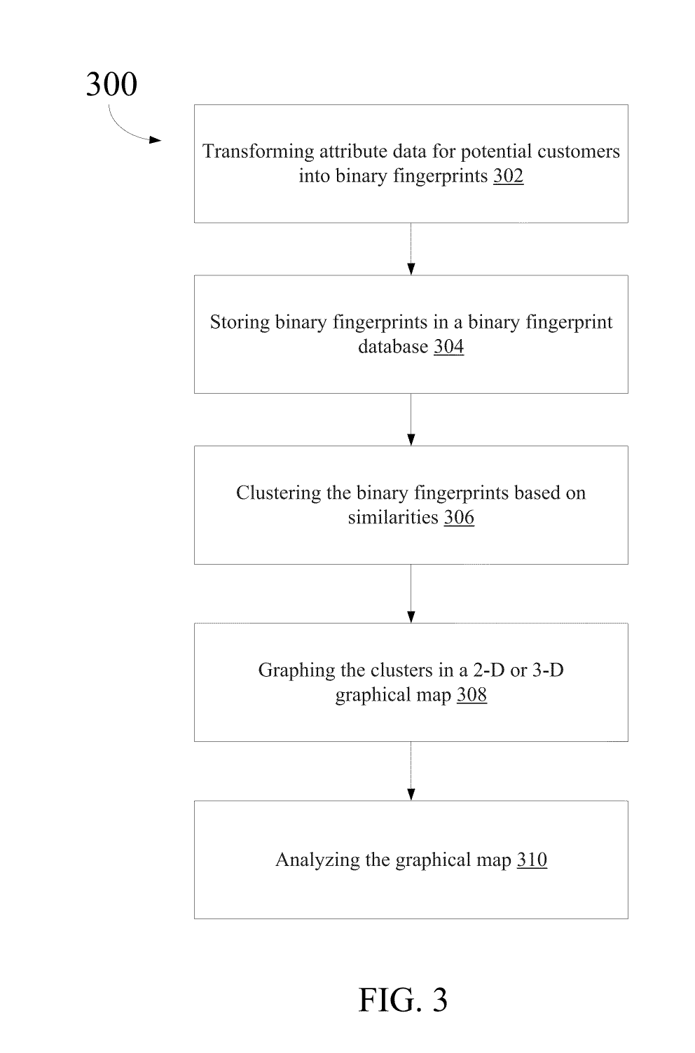

FIG. 3 is a flow chart that describes an illustrative method 300 of identifying segments of the potential customer population according to behavioral and demographic attributes. As mentioned above, databases have been produced that contain behavioral and demographic attributes representing various portions of the population of the U.S. These portions of the U.S. population can be considered as potential customers. Also, companies have produced databases that contain similar behavioral and demographic attributes of their existing customers. According to the presently disclosed and claimed method, these attribute data can be transformed 302 into bit sets or binary fingerprints to facilitate graphical mapping and analysis. A fuller description of how the behavioral and demographic information may be transformed into bit sets or binary fingerprints is set out below. These bit sets or binary fingerprints may be stored 304 in a binary fingerprint database for later analysis.

These binary fingerprints then are clustered 306 into clusters according to the similarity in the binary fingerprints. An illustrative method of clustering similar binary fingerprints is by means of methods well known in the field of chemical structure analysis. According to this known methodology, chemical structures are compared to each other by comparing bit sets, that is, without the need to draw representations of chemical structures and compare these representations themselves. In the present case, attributes of potential customers are compared to attributes of other potential customers by comparing bits sets without the need to compare the attributes themselves. This approach is based on the concept that similar potential customer attribute profiles have similar bit sets. An illustrative example of this clustering process is by means of what is known as fuzzy clustering, which is well known and well described in the literature of chemical structure comparisons. Other clustering methodologies are known in the art and may be used in accordance with the principles described herein.

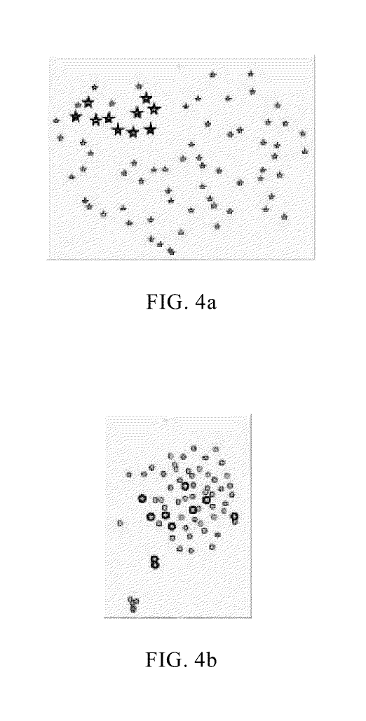

After clustering 306 the binary fingerprints based on their similarities, the clusters may be graphed 308 in a two-dimensional or three-dimensional map by means of non-linear mapping or multidimensional scaling technologies according to methods well known in the art. An example of a two-dimensional map produced according to this technology is shown in FIG. 4a. Each dot on the two-dimensional map represents a cluster of binary fingerprints. The number of dots on the map, and consequently the number of binary fingerprints represented by each dot on the map, may be selected by the user of the method. For example, if 200 million individuals were represented in a potential customer database, and the use of the method selected 100,000 as the number of dots to be graphed on the map, then each dot on the resulting map would represent 200 million divided by 100,000, or an average of 2000 binary fingerprints. Similarly, the user of the method could select a number of binary fingerprints to be represented by each dot on the map, and by the appropriate arithmetic operation determine the number of dots that would be needed to achieve that result. Typically, it is convenient for each dot on the map to represent about 1000 to about 10,000 binary fingerprints.

Referring again to FIG. 3, the graphical map can be analyzed 310 to obtain information about potential customers. For example, examination of FIG. 4a shows that there are regions on the map where the dots are relatively close together, and there are other regions on the map where the dots are relatively far apart. This information is useful to a company, because it shows how a company can direct its marketing efforts to achieve a good likelihood of success and suggests how other types of marketing efforts are unlikely to have success. Further, each dot on the graphical map of FIG. 4a can be scrutinized in more detail by “drilling down” on the cluster and examining the individual binary fingerprints and their associated attributes that comprise the cluster. FIG. 4b is a representation in two-dimensions of individual binary fingerprints from a cluster selected from FIG. 4a. FIG. 4b also shows that there are regions of the map where the binary fingerprints are relatively close together and other regions where the binary fingerprints are farther apart. Again, this information can be used in designing marketing campaigns to target selected segments of individuals according to the behavioral and demographic information represented by their binary fingerprints.

Experian (Costa Mesa, Calif.) is a company that has developed a list of about 700 attributes that can be used to identify customers and potential customers and has produced a database ostensibly identifying each adult in the U.S. according to selected behavioral and demographic information that Experian has collected. In this sense, “identify” refers to what kind of person the potential customer is in terms of a large set of these behavioral and demographic attributes instead of who the person is in terms of name, address, and so forth. These attributes include income level, whether the person is a homeowner, educational level, gender, age, number of children in the home, and so forth. These attributes can generally be expressed with a yes or no answer to a question. Examples of such questions include the following. Is the person age 26-30? Does the person have an annual income of $50,000 to $75,000? Does the person have children in the home? Is the person a college graduate? The answers to these questions can be expressed as sets of bits, where “1” represents the presence of the attribute and “0” represents the absence of the attribute. Thus, the attribute of whether the person is 26-30 years old can be represented by a single bit of information. Therefore, for the list of about 700 attributes, a space of about 700 dimensions can be used to identify virtually every adult in the U.S. Said another way, each adult in the U.S. can be represented by a set of about 700 bits of information. A database containing about 200 million 700-bit sets can represent virtually every U.S. adult.

After the customer profile data are transformed into, i.e. bit sets, binary fingerprints, the binary fingerprints may be stored in a binary fingerprint database. These binary fingerprints may then be clustered into clusters according to the similarity in the binary fingerprints. An illustrative method of clustering similar binary fingerprints is by means of methods well known in the field of chemical structure analysis, such as is used in the biotechnology industry. According to this known methodology, chemical structures are compared to each other by comparing bit sets, that is, without the need to draw representations of chemical structures and compare these representations themselves. In the present case, attribute profiles are compared to other attribute profiles by comparing bits sets without the need to compare the attribute profiles themselves. This approach is based on the concept that similar attribute profiles have similar bit sets. An illustrative example of this clustering process is by means of what is known as fuzzy clustering, which is well known and well described in the literature of chemical structure comparisons. Other clustering methodologies are known in the art and may be used in accordance with the principles described herein.

For a binary fingerprint database containing about 200 million separate binary fingerprints, it would be convenient to cluster these binary fingerprints into 100,000 clusters each having on average about 2000 binary fingerprints.

### Example 1

In this example, the approximately 700 behavioral and demographic attributes of the Experian database are considered. Each of these attributes may be converted into an integer index. For example, if there were exactly 700 attributes being considered, then each attribute would be assigned an integer, numbered 0 to 699. As an example, the person's gender might correspond to 10 in the integer index. If the person were male, then the 10th bit in the bit set could be set to 1. If the person were female, on the other hand, then the 10th bit in the bit set could be set to 0. As another example, the attribute of a person having an annual income of $50,000 to $75,000 might correspond to 150 in the integer index. Therefore, if the person actually had an annual income of $50,000 to $75,000, then the 150th bit in the bit set would be set at 1. If the person had an income outside the range of $50,000 to $75,000, however, then the 150th bit in the bit set would be left at 0, and whatever bit in the bit set that corresponded in the integer index to the person's actual annual income would be set at 0 while all other bits relating to annual income ranges would be left at 0.

The similarity between two profiles is the Tanimoto (or, equivalently, the Jaccard) similarity, measured as the number of l's that are in both of the two profiles divided by the number of l's that are in at least one of the two profiles. This is then the fraction of all l's in the two profiles that are shared between them.

Customer attribute profiles that are not closely related will have a low similarity (generally less than 0.100), while customer attribute profiles that are closely related will have a high similarity (roughly 0.500 and higher) using this method. Of course, a Tanimoto similarity of 0 indicates that the customer attribute profiles being compared have no attribute similarities, and a Tanimoto similarity of 1 indicates that the customer attribute profiles being compared are identical.

Clustering methods, such as fuzzy clustering, are used cluster the customer attribute profiles according to their Tanimoto similarities. The clusters can then be represented on a two- or three-dimensional map using non-linear mapping or multidimensional scaling techniques according to methods well known in the art.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for identifying attributes of potential customers from a potential customer database, the method comprising:
with a processor, transforming attribute data associated with each entry in a potential customer database into a binary fingerprint and storing said binary fingerprint in a binary fingerprint database comprising a plurality of binary fingerprints;
with a processor, clustering the plurality of binary fingerprints in the binary fingerprint database into clusters based on similarities among the plurality of binary fingerprints;
with a processor, graphing the clusters in a two-dimensional or three-dimensional graphical map; and
analyzing the graphical map for identifying attributes of potential customers.

2. The method of claim 1, wherein the potential customer database comprises attribute data for approximately every adult in the United States.

3. The method of claim 1, wherein clustering the plurality of binary fingerprints produces a selected number of clusters.

4. The method of claim 1, wherein clustering the plurality of binary fingerprints produces clusters comprising a selected average number of binary fingerprints.

5. The method of claim 1, wherein similarities among the plurality of binary fingerprints are determined by calculating Tanimoto or Jaccard similarities.

6. The method of claim 1, wherein clustering the plurality of binary fingerprints is achieved by fuzzy clustering technology.

7. The method of claim 1, wherein graphing the clusters in a two-dimensional or three-dimensional graphical map is achieved by multidimensional scaling or non-linear mapping.

8. The method of claim 1, wherein each cluster in the two-dimensional or three-dimensional map represents about 1000 to about 10,000 binary fingerprints.

9. The method of claim 1, wherein analyzing the graphical map for identifying attributes of potential customers comprises selecting one or more clusters and examining attributes associated with said selected clusters.

10. A system for identifying attributes of potential customers from a potential customer database comprising: one or more processors and one or more memory devices operably coupled to the one or more processors and storing executable and operational data, the executable and operational data effective to cause the one or more processors to:
transform attribute data associated with each entry in a potential customer database into a binary fingerprint and store said binary fingerprint in a binary fingerprint database comprising a plurality of binary fingerprints;
cluster the plurality of binary fingerprints in the binary fingerprint database into clusters based on similarities among the plurality of binary fingerprints;
graph the clusters in a two-dimensional or three-dimensional graphical map; and
analyze the graphical map for identifying attributes of potential customers.

11. The system of claim 10, wherein the potential customer database comprises attribute data for approximately every adult in the United States.

12. The system of claim 10, wherein the step to cluster the plurality of binary fingerprints produces a selected number of clusters.

13. The system of claim 10, wherein the step to cluster the plurality of binary fingerprints produces clusters comprising a selected average number of binary fingerprints.

14. The system of claim 10, wherein similarities among the plurality of binary fingerprints are determined by calculating Tanimoto or Jaccard similarities.

15. The system of claim 10, wherein the step to cluster the plurality of binary fingerprints is achieved by fuzzy clustering technology.

16. The system of claim 10, wherein the step to graph the clusters in a two-dimensional or three-dimensional graphical map is achieved by multidimensional scaling or non-linear mapping.

17. The system of claim 10, wherein each cluster in the two-dimensional or three-dimensional map represents about 1000 to about 10,000 binary fingerprints.

18. The system of claim 10, wherein the step to analyze the graphical map for identifying attributes of potential customers comprises selecting one or more clusters and examining attributes associated with said selected clusters.
